(19) United States
(12) Patent Application Publication
(10) Pub. No.: US 2022/0097842 A1
(43) Pub. Date: Mar. 31, 2022

(54) RUGGED UNMANNED AIRBORNE VEHICLE

(71) Applicant: Travis Kunkel, Mineral Wells, TX (US)

(72) Inventor: Travis Kunkel, Mineral Wells, TX (US)

(21) Appl. No.: 17/035,516

(22) Filed: Sep. 28, 2020

(51) Int. Cl. B64C 39/02; B64D 27/24

(52) U.S. Cl. CPC B64C 39/024; B64D 27/24; B64C 2201/108; B64C 2201/042; B64C 2201/027

(57) ABSTRACT

The invention is a ruggedized unmanned aerial vehicle constructed to resist small arms fire and collisions, as well an assembly that allows for ease of repair and reconfiguration to minimize downtime for an individual drone unit suitable for military use.

### FIELD OF THE INVENTION

The present invention relates to the construction of unmanned aerial vehicles known as “drones” and popularly constructed to accomplish reconnaissance and delivery of payloads.

### BACKGROUND

Individuals can use autonomous vehicles (“AV”) as instruments for specific missions, such as surveillance, lighting, and entertainment. Embodiments of AVs are configured to operate in air, on land, and in water, in this embodiment the AV is configured to operate in air, the scope of this patent should not be limited to this configured embodiment but to all configurations thereof.

A typical autonomous vehicle comprises a local memory and electric motor powered by a battery that is programmed to perform predetermined missions and flight plans. Alternatively, an AV could be driven using a gas engine fed by an AV-mounted fuel tank.

Drones are typically made of an inexpensive light-weight plastic or carbon-fiber to maximize flight time. These industry standard practices lead to a drone that are easily destroyed by collisions and cannot survive the mildest of physical attacks. Many drones are constructed as one piece and if an arm or if the body is damaged it is not easily repaired, if at all.

### SUMMARY OF THE INVENTION

This application uses a construction that welcomes fast-changing of damaged parts and survives small arms fire and collisions, and provides a platform for payloads, consequently creating a drone that survives a minimum of 375-lb crush test.

This application features a central lightweight body containing hardware and controllers with attachable arms able to be easily replaced from the body.

In one of several alternative embodiments, the drone uses arms made of aluminum and covered by a protective braided Kevlar material, the arms designed for easy replacement.

Additionally, the drone arms are constructed with commercially common rails such as those found on an AR-15 rifle. This structure allows users to mount optics or payloads without making modifications to the drone. The bottom of the central body also features these rails for additional modifications.

### BRIEF DESCRIPTION OF THE DRAWINGS

FIG. 1 shows an orthogonal perspective view of one embodiment of a four-rotor version of the invention;

FIG. 2 shows an exploded view of the drone and central body and arm elements of the embodiment shown in FIG. 1;

FIG. 3 shows a top view of the embodiment shown in FIG. 1;

FIG. 4 shows a bottom view of the embodiment shown in FIG. 1;

FIG. 5 shows an exploded view of an arm element from the embodiment shown in FIG. 1;

FIG. 6 shows a front view of the embodiment shown in FIG. 1; and

FIG. 7 shows a side view of the embodiment shown in FIG. 1.

The present invention will now be described by referencing the appended figures representing preferred embodiments.

### DETAILED DESCRIPTION

The invention as embodied is a four-rotor drone that is built to be sufficiently rugged and employ a construction allowing for quick change and repair of damaged arms.

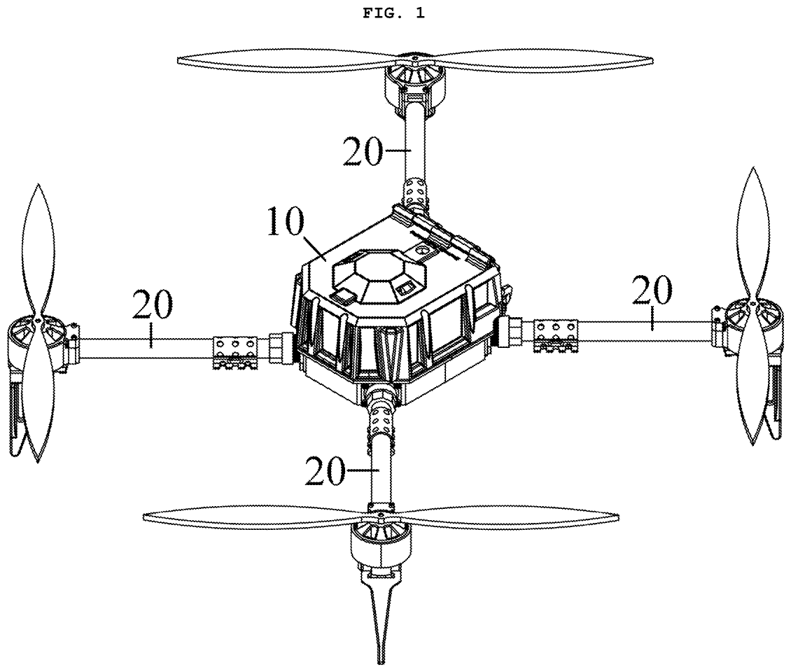

FIG. 1 shows an orthogonal perspective view of one embodiment of a four-rotor version of the invention. As shown in FIG. 1, the drone 100 features a central body 10 comprising hardware for remote control and configured to receive instructions. The central body 10 comprises a plurality of connection ports to attach and secure a plurality of arms 20 that may feature a plurality of propellers 30. The arms 20 may be made of aluminum tubes 120 comprising arm rail mounts 70 to mount optics or payloads.

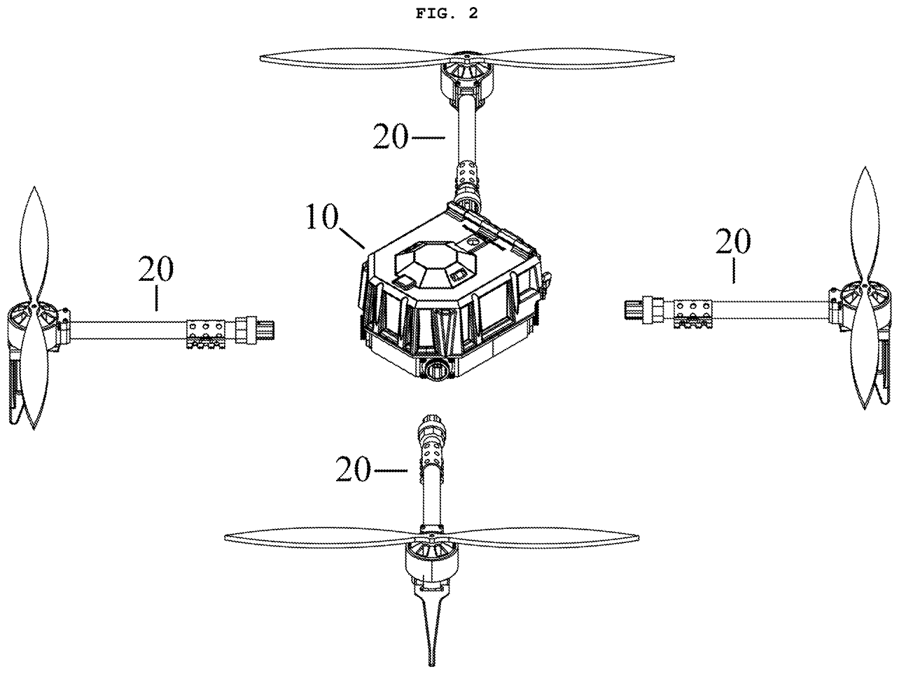

FIG. 2 shows an exploded view of the drone 100, central body 10, and arm 20 elements of the embodiment shown in FIG. 1. The central body 10 comprises hardware configured to receive instructions for tasks to be executed by the drone 100. The central body 10 may comprise connection ports to attach replaceable arms 20 comprising aluminum tubes 70 and configured to hold the propellers 30. In one embodiment, the arms 20 comprise arm rail mounts 70 that may mount optics or payloads. In one embodiment, the aluminum tubes 70 may be wrapped in braids 65 made of synthetic fiber. In one embodiment, the synthetic fiber may be Kevlar®.

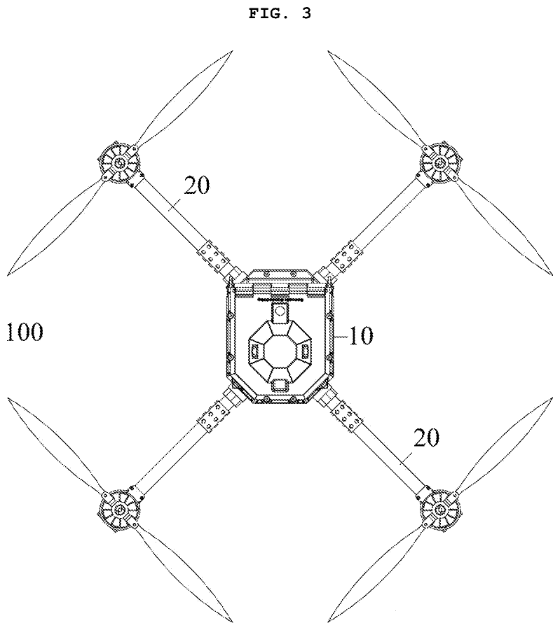

FIG. 3 shows a top view of the embodiment shown in FIG. 1. The drone 100 comprises a central body 10 that may be removably coupled to a plurality of arms 20 that comprise propellers 30. The arms 20 may comprise aluminum tubes 120 wrapped in Kevlar® braid 65 and may comprise arm rail mounts 70 to mount mission-related tools such as, but not limited to, optics or payloads. One of ordinary skill in the art will understand that a plurality of mission-related tools may be mounted to the arm rail mounts 70 relative to different missions and are understood herein.

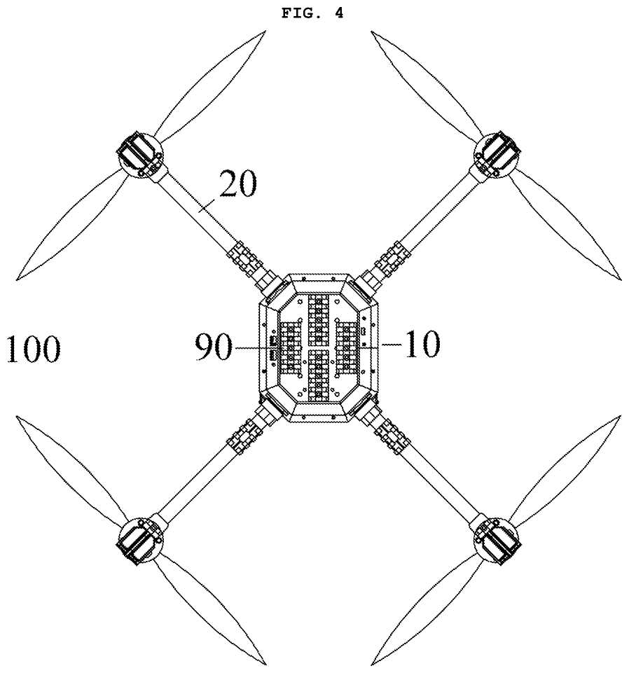

FIG. 4 shows a bottom view of the embodiment shown in FIG. 1. The drone 100 comprises a central body 10 and arms 20 that may be configured to removably couple to the central body and be easily replaced. The bottom of the central body 10 comprises a body rail mount 90 which may be configured to attach mission-related tools such as, but not limited to, optics or payloads.

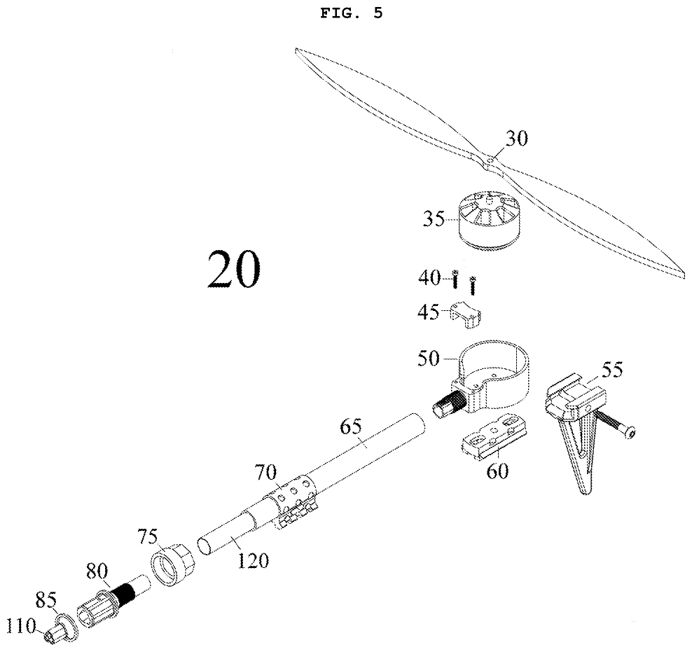

FIG. 5 shows an exploded view of an arm 20 element from the embodiment shown in FIG. 1. The arm 20 comprises an aluminum tube base 120 wrapped in a Kevlar braid 65 and further comprises an arm rail mount 70 configured to removably attach mission-related tools such as, but not limited to, optics and payloads. The arm 20 removably couples to the central body 10. In one embodiment, the arm 20 removably couples to the central body 10 with an arm connection 75 around the aluminum tube base 120 and connection seal 80, and fitting within the central body 10 with the sealing ring 85 allowing connection of the arm 20 to the central body 10 through an electrical connection 110. The propeller 30 may be configured to attach to a motor 35 and may be fastened to a motor mount 50 by at least one of retention bolts 40 and a retention bracket 45. A rail 60 may be attached to a bottom side of the motor mount 50 with a stand 55 sliding and fastened onto the rail 60 to hold the drone 100 in an up-right position when on the ground. In one embodiment, in response to impact from a high-velocity projectile, an arm 20 impacted by the high-velocity projectile may be removed and another functioning arm 20 may be attached. In one embodiment, the removing the impacted arm 20 and attaching the functioning arm 20 comprises transferring mission-related tools being carried on the rails 60 on the bottom side of the impacted arm 20 to rails 60 on a bottom side of the functioning arm 20. In one embodiment, the removing the impacted arm 20 and attaching the functioning arm 20 may be executed by a user. In another embodiment, the removing the impacted arm 20 and attaching the functioning arm 20 may be executed by a user, for example, at a control station.

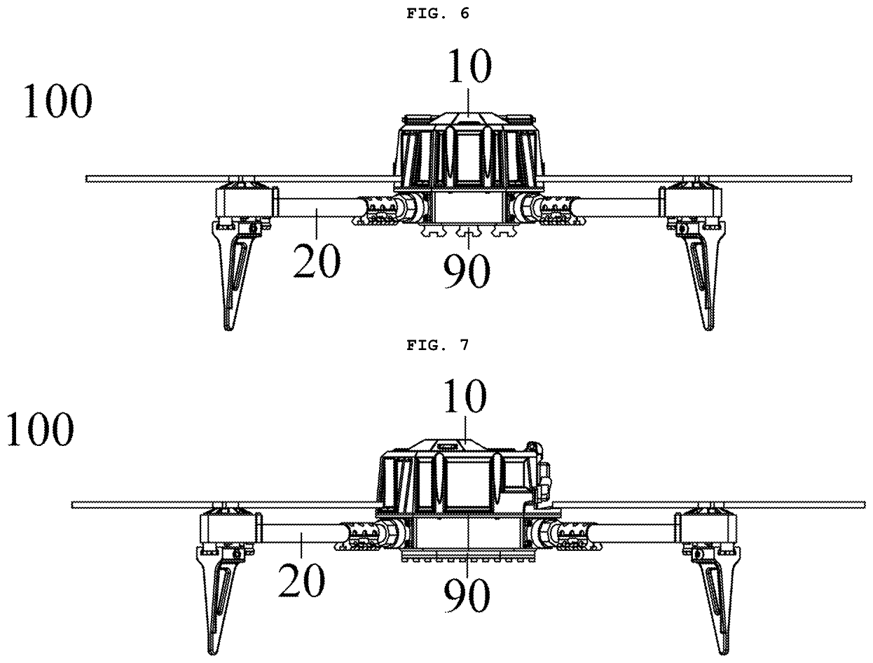

FIG. 6 shows a front view of the drone 100 from the embodiment shown in FIG. 1. The central body 10 may be attached to arms 20 and comprises a body rail mount 90 on a bottom side to attach mission-related tools such as, but not limited to, optics and payloads.

FIG. 7 shows a side view of the drone 100 from the embodiment shown in FIG. 1. The drone 100 comprises a central body comprising hardware to receive instructions and may be attached to arms 20. A bottom of the body 90 may comprise a body rail mount 90 to attach mission-related tools such as, but not limited to, optics and payloads.

### LEGEND OF SYSTEM ELEMENTS

10 Central Body
20 Arm
30 Propeller
35 Motor
40 Retention Bolts
45 Retention Bracket
50 Motor Mount
55 Stand
60 Rail
65 Kevlar Braid
70 Arm Rail Mount
75 Arm Connection
80 Connection Seal
85 Sealing Ring
90 Body Rail Mount
100 Drone
110 Electrical Connector
120 Aluminum Tube

### Standard Nonlimiting Verbiage

The terminology used herein is for the purpose of describing particular embodiments only and is not intended to be limiting of the invention. As used herein, the term “and/or” includes any and all combinations of one or more of the associated listed items. As used herein, the singular forms “a”, “an”, and “the” are intended to include the plural forms as well as the singular forms, unless the context clearly indicates otherwise. It will be further understood that the terms “comprises” and “comprising”, when used in this specification, specify the presence of stated features, steps, operations, elements, and components, but do not preclude the presence or addition of one or more other features, steps, operations, elements, components, or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Never-theless, the specification and claims should be read with the understanding that such combinations are entirely within the scope of the invention and the claims.

The present disclosure is to be considered as an exemplification of the invention, and is not intended to limit the invention to the specific illustrated embodiments and description. For example, the drawings show a four-rotor drone, but the invention is applicable to drone using any number of rotors.

1. An unmanned airborne vehicle, comprising:
a central body;
a plurality of arms removably coupled to the central body at inner ends of the plurality of arms; and
wherein each of the plurality of arms comprises:
a propeller coupled to an outer end of the arm;
a tube, the tube comprising a rail;
wherein the rail is configured to receive mission-related tools; and
wherein the tube is covered by a synthetic fiber designed to resist high-velocity projectiles.

2. The unmanned airborne vehicle according to claim 1, wherein the central body comprises hardware configured to receive instructions for tasks to be executed by the unmanned airborne vehicle.

3. The unmanned airborne vehicle according to claim 2, wherein the hardware comprises a computer readable medium.

4. The unmanned airborne vehicle according to claim 1, wherein the plurality of arms comprises four arms.

5. The unmanned airborne vehicle according to claim 1, wherein the mission-related tools comprise at least one of optics and payloads.

6. The unmanned airborne vehicle according to claim 1, wherein the synthetic fiber comprises Kevlar®.

7. The unmanned airborne vehicle according to claim 1, wherein the rail is configured to run on a bottom side of the tube.

8. The unmanned airborne vehicle according to claim 1, wherein the tube comprises an aluminum tube.

9. The unmanned airborne vehicle according to claim 1, wherein the rail comprises a rail mount for securing the mission-related tools to the rail.

10. The unmanned airborne vehicle according to claim 1, wherein the propeller is coupled to a motor that is housed in a motor mount, wherein the motor mount is detachably coupled to the arm.

11. The unmanned airborne vehicle according to claim 10, wherein the motor mount comprises a stand for holding the unmanned airborne vehicle upright when sitting on a surface.

12. A method for operating an unmanned airborne vehicle, comprising:
communicating tasks to be completed by the unmanned airborne vehicle to hardware in a central body of the unmanned airborne vehicle;
utilizing mission-related tools being carried on rails on the bottom side of arms of the unmanned airborne vehicle, the arms being covered in a synthetic fiber and removably coupled to the central body;
in response to impact from a high-velocity projectile, removing an arm impacted by the high-velocity projectile and attaching another functioning arm, wherein the removing the impacted arm and attaching the functioning arm comprises transferring the mission-related tools being carried on the rails on the bottom side of the impacted arm to rails on a bottom side of the functioning arm.

13. The method according to claim 12, wherein the removing the impacted arm and attaching the functioning arm is executed by a user.
